(19) United States
(12) Patent Application Publication
(10) Pub. No.: US 2026/0005278 A1
(43) Pub. Date: Jan. 1, 2026

(54) FUEL CELL STACK

(71) Applicant: MTU Aero Engines AG, München (DE)

(72) Inventors: Ann-Kathrin Henss, Munich (DE); Barnaby Law, Starnberg (DE); Wolfram Kaiser, Schonberg (DE)

(73) Assignee: MTU Aero Engines AG, München (DE)

(21) Appl. No.: 18/881,546

(22) PCT Filed: Jul. 4, 2023
(86) PCT No.: PCT/DE2023/100504

§ 371 Date: Jan. 6, 2025

(30) Foreign Application Priority Data
Jul. 11, 2022 (DE) 10 2022 117 157.4

(51) Int. Cl. H01M 8/248; B64D 27/355; H01M 8/2475

(52) U.S. Cl. CPC H01M 8/248; B64D 27/355; H01M 8/2475; H01M 2250/20

(57) ABSTRACT

The present invention relates to a fuel cell stack, having fuel cells arranged successively in a stacking direction, an inner covering element, which follows the fuel cells in the stacking direction, and an outer covering element, which follows the inner covering element in the stacking direction and holds the inner covering element and the fuel cells together in a braced state, wherein the outer covering element forms at least a first spring element and a second spring element perpendicularly to the stacking direction, wherein each of the spring elements forms an arc profile that is convexly curved in the direction of the inner covering element and the respective arc profile is separately suspended, and wherein the inner covering element for the spring elements forms a respective receptacle, each being concavely curved in the direction of the outer covering element and accommodating the respective concavely curved arc profile.

### BACKGROUND OF THE INVENTION

The present invention relates to a fuel cell stack, in particular for a propulsion unit of an aircraft.

In a fuel cell stack, also referred to as a stack, a plurality of fuel cells are arranged successively in a stacking direction. A channel plate having a channel structure for gas distribution or for cooling, such as, for instance, a so-called bipolar plate, can be arranged between every two cells. The power or voltage of the stack can be adjusted to the application through the number of fuel cells connected in series in this way.

### SUMMARY OF THE INVENTION

The present invention is based on the technical problem of specifying an advantageous fuel cell stack.

This problem is solved in accordance with the invention by the fuel cell stack according the present invention. Provided in it are an inner covering element and an outer covering element, which hold the fuel cells together with a pressing force. Perpendicularly to the stacking direction, the outer covering element forms a plurality of spring elements, which, in the braced state, are thereby pressed against the inner covering element, which then transmits the pressing force onto the stacked fuel cells. The spring elements are constructed in such a way that each of them forms an arc profile that is convexly curved in relation to the inner covering element. These arc profiles are separately suspended for each spring element; that is, they are decoupled from one another. The inner covering element accommodates the arc profiles, forming for each spring element a respective receptacle that is concavely curved in the direction away from the stacked fuel cells and in which the respective arc profile is arranged.

The use of convexly curved arc profiles allows, for example, relatively large surface area moments of inertia to be realized; that is, for example, a sufficient transmission of the pressing force even in the case of a reduced profile thickness is made possible. A reduction in the profile thickness can be of interest in view of requirements for lightweight constructions and thus in mobility applications, in particular in the aviation sector. The combination of a convex profile and a concave receptacle, which, in the braced state, rest flush against each other, can thereby also result in an equalization of the force transmission over the surface area; for example, it can especially counteract an otherwise centrally reduced application of force that, under certain circumstances, results due to warping.

Owing to the “separate suspension,” the individual arc profiles are decoupled from one another. The displacement or deformation or pressure application of an arc profile, for example, does not also result automatically in a displacement/deformation of the nearest-neighboring arc profile. Hence, the successively arranged spring elements can each be adjusted specifically to the pressing force required in its respective surface region, without any interaction ensuing between the regions. The subdivision into a plurality of spring elements connected in parallel, for example, can help to compensate further for a center/edge difference; for example, it is possible to provide in the center a stiffer spring element, so that, for example, in spite of any warping of the covering elements resulting from a bracing with tension anchors extending laterally next to the stacked cells, for instance, a sufficiently large pressing force can be applied at the center.

Through the use of a plurality of spring elements, however, it is also possible, for example, to address different operating conditions and/or fuel cell designs (for example, segmentation; see below for details), whereby an equalization of the pressing force can be achieved or a deviating pressing force can be adjusted locally in a specific manner in the region of a seal, for example, over the entire surface area and, on account of the special design of the respective spring element, also within a partial surface area thereof.

Preferred embodiments are to be found in the dependent claims and in the entire disclosure, whereby, in the description of features, a distinction is not always made in detail between device aspects and method or use aspects; in any case, the disclosure is to be read implicitly in terms of all claim categories. If, for example, a certain fuel cell stack is described, the description is also to be read at the same time as a disclosure of a propulsion unit having such a stack or as a disclosure of the use thereof in an airplane or aircraft.

In the “stacking direction,” the fuel cells are arranged successively. In the direction perpendicular to this, they each have, for example, their surface area extension (and, in accordance therewith, their surface area is defined). In detail, the respective fuel cell can have, for example, a catalyst-coated membrane layer or “catalyst membrane layer” and a plate, in particular a bipolar plate, which forms a channel structure (flowfield), via which the catalyst membrane layer can be supplied with a reaction gas, for example. This channel structure can be sealed toward the outside and/or, in the case of a segmentation, also within the surface area by use of a seal, for example, whereby the seal is then braced in the stack as well. It is thereby possible for a different stiffness to ensue locally over the surface area of the stack, which, for example, through a corresponding adjustment of the spring element arranged in the respective region (of the seal or of the catalyst membrane layer), can be compensated at least in part. If, for example, a higher pressing force is required in an surface area region of the stack, a stiffer spring element can be arranged in alignment in the stacking direction (increased stiffness due to, for example, a larger profile thickness and/or a stiffened carrier or a smaller curvature of the arc profile).

The first and second spring elements, that is, the at least two spring elements, of the outer covering element each form an arc profile. As viewed in a sectional plane that lies parallel to the stacking direction and perpendicular to an axis of curvature, around which the respective arc profile is curved, the profile defines an arc line, which is convexly curved as viewed from the inner covering element and thus the fuel cells. In general, the profile can vary perpendicularly to said sectional plane; that is, for example, the arc line can take on different lengths. Preferred, however, is an arc profile that is translationally symmetric along the axis of curvature.

Preferably, the arc profile is exclusively convexly curved; that is, in other words, the sign of the curvature does not change along the arc line. The reference to the “axis of curvature” does not necessarily hereby imply that there is no curvature with a constant radius. For example, the arc line, viewed sectionally, can follow differently large radii of curvature over its course. The axis of curvature of the arc profile is determined according to its curvature at the maximum, that is, at the point nearest to the fuel cells.

In accordance with a preferred embodiment, a respective arc profile is suspended on a respective carrier pair and, namely, on account of the desired decoupling, on its own respective carrier pair. Therefore, two nearest-neighboring arc profiles do not share a carrier, for example, which would run counter to the desired decoupling. Each of the spring elements has a first carrier and a second carrier, which, together with each other, carry the respective arc profile of the respective spring element and, for reasons of simplicity, are referred to as a “carrier pair.”

In general, each spring element or arc profile can be provided with a further carrier in addition to the first carrier and second carrier; that is, as viewed in the above-mentioned sectional plane, the arc profile can be suspended at more than two points. Preferably, however, it is suspended exclusively on the first carrier and second carrier; that is, the carrier pair alone carries the arc profile. As viewed in said sectional plane, the first carrier and second carrier extend away from the inner covering element toward each other and therefore form struts of the arc line. Preferably, they meet at a suspension point.

This suspension point is preferably arranged in the stacking direction in alignment with the associated carrier profile; that is, it is not laterally displaced with respect to the associated carrier profile. In a preferred embodiment, the suspension point is arranged in alignment with the maximum of the arc profile; that is, the maximum and the suspension point lie on a common straight the line parallel to the stacking direction (as viewed in said sectional plane). The maximum of the arc profile ensues, as viewed in the sectional plane, as that point on the arc profile that is nearest to the stacked fuel cells.

In accordance with a preferred embodiment, the first carrier and second carrier of the respective carrier pair are mirror-symmetric with respect to each other as viewed in the sectional plane. The associated mirror axis lies preferably parallel to the stacking direction and/or passes through the maximum and the suspension point (see above), preferably both.

Insofar as, in general, reference is made to a “lateral direction,” this direction is pointed sideward and thus lies perpendicularly to the stacking direction. In detail, then, a distinction is made between a first lateral direction and a second lateral direction perpendicular to it, with the first lateral direction lying, as per definition, perpendicularly to the axis of curvature of the arc profile of the first spring element. The “sectional plane” mentioned above in connection with the geometry of the profile and/or of the carrier, specifically the associated sectional plane, lies parallel to the first lateral direction (and to the stacking direction). The second lateral direction lies parallel to the axis of curvature and thus perpendicular to the first lateral direction.

In a preferred embodiment, in the first lateral direction and/or in the second lateral direction, at least two spring elements are arranged next to each other. In principle, it is possible to brace a matrix of any size, albeit obviously depending on the surface area of the fuel cell stack (the theoretical upper limits of the spring elements arranged successively in a respective direction can be, for example, at most 1,000, 500, 100, 50, or 20). In general, the spring elements can also be “skewed” with respect to one another; that is, for example, the axis of curvature of the arc profile of the second spring element can lie at an angle to that of the first spring element. Preferred, however, is an arrangement with axes of curvature that are parallel with respect to each other, this further holding true preferably for all spring elements of the outer covering element. With a view to standardization and simplification of the geometry, a construction can be preferred to the extent that at least some or else all of the spring elements arranged successively in the first lateral direction are translationally symmetric with respect to one another (in the first lateral direction) and/or some or all of the spring elements arranged successively in the second lateral direction are translationally symmetric with respect to one another (in the second lateral direction), at least groupwise in each instance.

In accordance with a preferred embodiment, the first spring element and the second spring element differ in the curvature of their arc profiles and/or in the thickness of their arc profiles and/or in the stiffness of their respective arc profile suspension, that is, in particular, of the carrier pairs. A stronger curvature, that is, a smaller curvature radius, and/or a larger profile thickness can be achieved, for example, by using a stiffer spring, this also holding true for the suspension. In this way, it is possible, for example, to achieve not only an equalization of the pressing force over the surface area, but also, for example, to adjust a greater pressing force even specifically region by region. In this way, it is possible in the region of seals, for example, to adapt the pressing force (compare the comments at the beginning).

In accordance with a preferred embodiment, the first spring element and the second spring element occupy differently large surface area portions. Thus, for example, projection surface areas that ensue by way of a perpendicular projection of the respective arc profile in a plane perpendicular to the stacking direction are different in size. All spring elements can differ in terms of their respectively occupied surface area portions; on the other hand, there can also ensue spring elements that have the same surface area portions groupwise and then differ only from group to group. The (at least in part) differently large surface area portions of the spring element can be matched to the outer covering element on the fuel cells (for seal regions and/or segmented regions, see below).

In accordance with a preferred embodiment, at least one of the spring elements in the stacking direction is suspended in alignment with a cavity created in the outer covering element. This cavity can be charged with a fluid, for which purpose, for example, a fluid channel can open into the cavity. The fluid can be a gas or a liquid and, through charging of the cavity, it is possible to achieve a certain deformation of the outer covering element and accordingly a displacement of the at least one spring element in the direction of the inner covering element. In this way, for example, it is possible to carry out a fine regulation in order to compensate for manufacturing deviations, for instance. Alternatively or additionally, the charging with liquid and the increase in the pressing force of the at least one spring element that is associated therewith can also serve for an adaptation to certain operating conditions, for example.

In a preferred embodiment, its own cavity in the outer covering is assigned to the first spring element and the second spring element, respectively, and, if these cavities can be charged with a fluid independently of each other, it is therefore possible to adjust independently the respective pressing force of the respective spring element. However, its own cavity can be assigned to each of the spring elements. Alternatively, though, it is also possible, for example, to assign spring elements in groups to the same cavity or else some of the spring elements can also not be assigned to any cavity (for example, those at the edge).

As mentioned at the beginning, a respective fuel cell can have a respective catalyst membrane layer, which, for example, separates hydrogen and oxygen and, at the same time, transports the protons from the anode to the cathode. It is preferred, at least in the core of the stack, to have a respective catalyst membrane layer enclosed on both sides by a respective bipolar plate; preferably, the bipolar plates form a respective channel structure on both sides, that is, also for each of nearest-neighboring fuel cells or catalyst membrane layers. In the stacking direction between a respective channel structure and a bipolar plate, it is possible to provide, in addition, a gas diffusion layer, which, for example, distributes the reaction gas at the electrode of the catalyst membrane layer and dissipates the flow from there (for example, also water and heat).

In accordance with a preferred embodiment, at least one of the fuel cells of the stack is segmented, that is, divided into at least two segments. To this end, it is possible in detail for the catalyst membrane layer and/or the channel structure to be segmented and, insofar as it is present, the gas diffusion layer can also be segmented. Regardless of these details, the segments of the fuel cell that ensue from this subdivision can also preferably be sealed with respect to one another; that is, a seal can be arranged in between with respect to directions perpendicular to the stacking direction. The covering element, in alignment with this seal in the stacking direction can then be furnished with a spring element, which is matched specifically to the bracing of this seal (or multiplicity of seals arranged successively in the stacking direction). Preferably, even when the fuel cell is partially segmented, it is equally possible to provide a continuous bipolar plate, which, for example, creates mechanical stability.

In a preferred embodiment, the arc profile or arc profiles is or are provided in such a way that, in the braced state, each of them rests flush against the respective receptacle, whereas, in the unbraced state, a gap is found between an arc profile and a concave receptacle at least in some regions. In the sectional plane, as viewed perpendicular to the axis of curvature, the unbraced arc profile can rest in the region of its maximum, for example, in the receptacle and a respective gap can be present on both sides. Preferably, a gap width hereby taken in the stacking direction away from the maximum toward the outside (toward the side) increases in each instance. The bracing causes the arc profile, starting at the maximum and increasing toward both sides, to be pressed outward; that is, the contact surface area between the arc profile and the receptacle increases (in the sectional view, the line of contact becomes longer). This accomplishes an increasing application of force in the inner covering element, whereby the pressing force transmitted onto the fuel cells also increases. Preferably, the concave receptacle or receptacles is or are each adapted to the respective arc profile such that, under nominal load, there exists a continuously flush surface area contact in between, preferably over the entire concave receptacle (the contact surface area therefore fills it out completely).

The invention also relates to a method for manufacturing a fuel cell stack, wherein the arc profiles of the outer covering element are arranged in the concave receptacles of the inner covering element and the outer covering element is braced against the inner covering element and thus against the fuel cells. For the bracing, in general, a pressing force in any form can be applied to the outer covering element, such as, for example, also by pressing or spreading a side facing away from the fuel cells. Preferably, however, the outer covering element is braced, at least indirectly, with one tensioning element or, in particular, a plurality of tensioning elements, such as, for example, tension anchors or tension bands, against the inner covering element and the fuel cells.

Preferably, the outer covering element is hereby pulled in the direction of a further covering element arrangement that is disposed at the opposite end of the stacked fuel cells. This further covering element arrangement can be made up of an inner covering element and an outer covering element (compare the preceding disclosure in regard to possible details). The tension anchors or tension bands hereby extend preferably outside of the stacked fuel cells, that is, laterally displaced (and, however, for example, parallel to the stacking direction). During bracing, even regardless of these details of the bracing, a respective arc profile is preferably pulled successively into the respective concave receptacle in an increasing contact in the way described above.

The invention also relates to a propulsion unit for an airplane or aircraft that has a presently disclosed fuel cell stack. Furthermore, it is directed at the use of such a propulsion unit or of the fuel cell stack in an airplane or aircraft.

### BRIEF DESCRIPTION OF THE DRAWING FIGURES

The invention is explained in detail below on the basis of exemplary embodiments, whereby the individual features in the scope of the dependent claims can also be of essence to the invention in other combinations and, furthermore, a distinction is not made in detail between the different claim categories.

Shown in detail are:

FIG. 1 is a fuel cell stack in a schematic sectional plane with an inner covering element and an outer covering element at the ends;

FIG. 2A is the inner covering element and the outer covering element in accordance with FIG. 1 in a detail view;

FIG. 2B is a detailed depiction in regard to FIG. 2A;

FIG. 3 is a segmented fuel cell in a detailed depiction.

### DESCRIPTION OF THE INVENTION

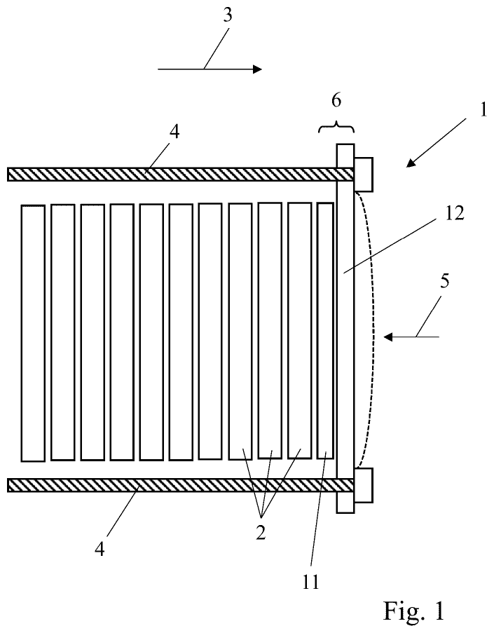

FIG. 1 shows a fuel cell stack 1 having a plurality of fuel cells 2 in a schematic sectional plane. The fuel cells 2 are arranged successively in a stacking direction 3, with this stack being mechanically held together by tension anchors 4. The tension anchors 4 transmit a pressing force 5 via a covering element arrangement 6 onto the stacked fuel cells 2, with an analogous arrangement being provided at the opposite end (not depicted here).

The present covering element arrangement 6 has an inner covering element 11 and an outer covering element 12, which follows the inner covering element 11 in the stacking direction 3. The force transmission from the tensioning elements 4 occurs onto the outer covering element 12, which holds together the stacked fuel cells 2 as well as the inner covering element 11 arranged in between. On account of the lateral transmission of force onto the outer covering element 12, a warping can occur, also depending on the surface area of the fuel cell stack 1 (compare the broken line in the overlying depiction for illustration).

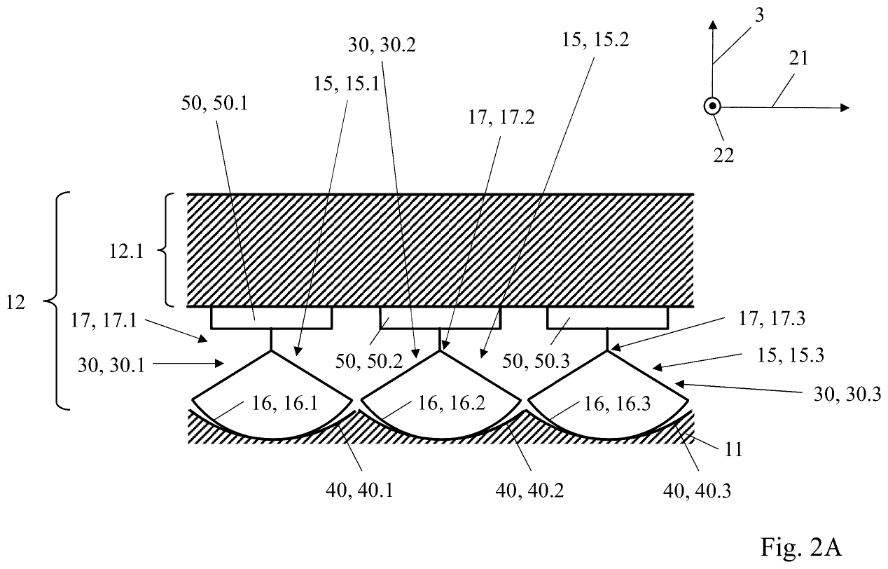

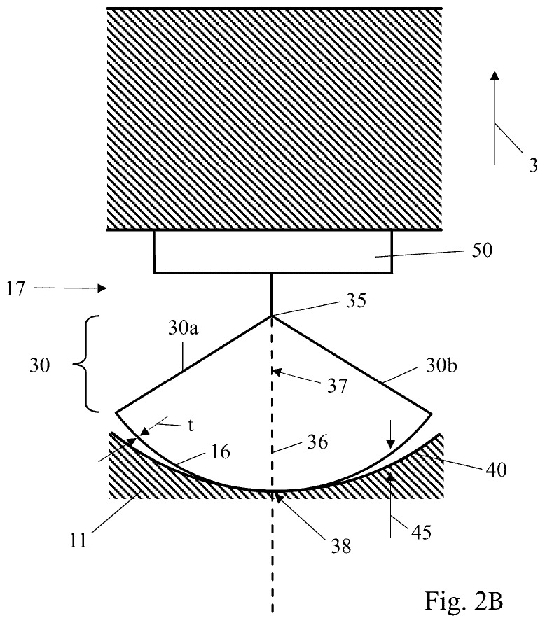

FIG. 2A illustrates the inner covering element 11 and the outer covering element 12 in a detailed depiction, namely, in a sectional plane parallel to the stacking direction 3 and the first lateral direction 21. The outer covering element 12 forms a plurality of spring elements 15, with, by way of example, a first, second, and third spring element 15.1, 15.2, 15.3 being referenced here. Each of the spring elements 15 forms toward the inner covering element 11 a convexly curved arc profile 16 (in accordance with the numbering, a first, second, and third arc profile 16.1, 16.2, 16.3). These arc profiles 16 are hereby decoupled from one another, namely, each of them being suspended by way of its own suspension 17, or, in accordance with the numbering, 17.1-17.3, on the inner covering element 11 and thus the section 12.1 of the outer covering element 12 distal to the fuel cells, via which the force transmission occurs from the tensioning elements (not depicted). Owing to the decoupling, each of the spring elements 15 can be adapted individually to the pressing force required in the respective surface region for the at least partial compensation of the warping illustrated in FIG. 1, for example.

The spring elements 15 each form an arc profile 16, the numbering of which corresponds to a first, second, and third arc profile 16.1-16.3. The arc profiles 16 are each suspended by way of a pair carrier 30 (compare the detailed depiction in FIG. 2B). This depiction illustrates the carrier pair 30, which comprises a first carrier 30a and a second carrier 30b, which each extend away from the arc profile 16, coming together in a suspension point 35. The carrier pair 30, that is, the first carrier and the second carrier 30a, b, are mirror-symmetric with respect to each other around a straight line 36 that is parallel to the stacking direction 3; the axis of curvature 37 perpendicular to the plane of the drawing and the maximum 38 of the arc profile 16 also lie on this straight line 36.

FIG. 2B shows an unbraced state. The arc profile 16 lies only in the region of the maximum 38 at a concave receptacle 40 formed by the inner covering element 11. Situated on each side of the maximum 38 is still a gap 45, the width of which increases going outward from the maximum 38 in each instance. If the outer covering element 12 is braced against the inner covering element 11 and thus against the stacked fuel cells, this gap closes successively until the arc profile 16 rests flush. On account of the high surface area moments of inertia, in particular in the region of the perpendicular line 36, it is possible with a relatively small profile thickness t to achieve a high pressing force. The surface area moment of inertia is high especially in the region of the maximum 38 or the maximum bending moment and decreases toward the sides and thus the force application positions.

FIG. 2A illustrates the spring elements 15 arranged successively in the first lateral direction 21 together with the respective arc profile 16 or 16.1-16.3 and the respective carrier pair 30 or 30.1-30.3. Perpendicular to the plane of the drawing, that is, in a second lateral direction 22, the spring elements 15 are translationally symmetric in construction; in this direction, too, there can be a plurality of spring elements in successive arrangement in each instance. In the outer covering element 12, a cavity 50 is additionally assigned to each of the spring elements 15, that is, in accordance with the numbering of the spring elements, 15.1-15.3, corresponding to a first, second, and third cavity 50.1-50.3. These cavities can be charged, independently of one another, with a fluid, gas, or liquid, so that, locally, through corresponding charging of the corresponding cavity, the corresponding spring element can be pressed more strongly (compare the introductory description for details).

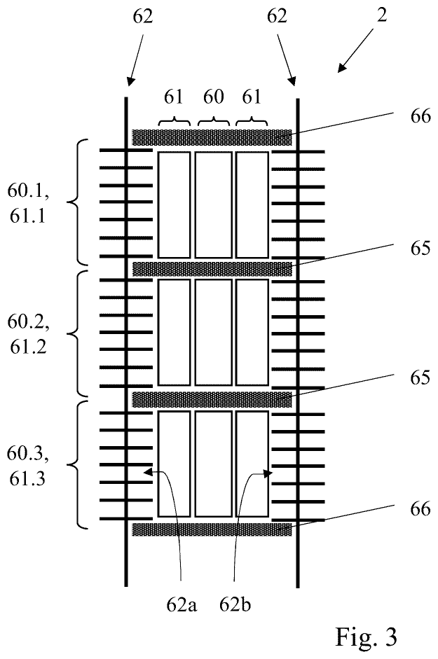

FIG. 3 shows a fuel cell 2 in a detailed depiction. It has a catalyst membrane layer 60, which is enclosed on both sides by a respective gas diffusion layer 61 and a respective bipolar plate 62. In the present case, a segmented construction is depicted; the catalyst membrane layer and the gas diffusion layer 60, 61 are therefore subdivided into a plurality of segments 60.1-60.3, 61.1-61.3. However, such a construction is not obligatory; the covering element arrangement described above can also be employed for non-segmented catalyst membrane and gas diffusion layers 60, 61 that, in contrast to FIG. 3, are therefore not separated by seals 65, but rather extend continuously. In this case, too, there would then exist the seals 66, for example, which enclose outward the catalyst membrane and gas diffusion layers 60, 61 and, in particular, the channel structures 62a, b formed by the bipolar plates 62. The segmentation depicted above in decoupled spring elements can be of interest with a view to such seals 65, 66, for example, making possible, namely, a locally adapted pressing force (compare introductory description for details).

1. A fuel cell stack, comprising:
fuel cells arranged successively in a stacking direction,
an inner covering element, which follows the fuel cells in the stacking direction, and
an outer covering element, which follows the inner covering element in the stacking direction and holds it as well as the fuel cells together in a braced state,
wherein, perpendicularly to the stacking direction, the outer covering element forms at least a first spring element and a second spring element, wherein
each of the spring elements forms an arc profile that is convexly curved in the direction of the inner covering element and
the respective arc profile is separately suspended,
and wherein the inner covering element for the spring elements forms a respective receptacle, each of which is concavely curved in the direction of the outer covering element and accommodates the respective concavely curved arc profile.

2. The fuel cell stack according to claim 1, wherein the arc profiles are each suspended on a pair carrier on a side facing away from the inner covering element, with its own pair carrier being provided for each arc profile.

3. The fuel cell stack according to claim 2, wherein, as viewed in a sectional plane, the pair carrier of the respective spring element comes together in a suspension point that is in alignment in the stacking direction with a maximum, which accommodates the respective arc profile in the direction of the inner covering element.

4. The fuel cell stack according to claim 2, wherein the pair carrier of the respective spring element, as viewed in the sectional plane, is mirror-symmetric in relation to a straight line that lies parallel to the stacking direction.

5. The fuel cell stack according to claim 1, wherein in a first lateral direction, which lies perpendicular to the stacking direction and to an axis of curvature of the arc profile of the first spring element, at least two spring elements are arranged next to each other.

6. The fuel cell stack according to one of the preceding claims claim 1, wherein, in a second lateral direction, which lies perpendicular to the stacking direction and parallel to an axis of curvature of the arc profile of the first spring element, at least two spring elements are arranged next to each other.

7. The fuel cell stack according to claim 1, wherein the first spring element and the second spring element differ in at least one of the following:
a curvature of the arc profiles (16.1, 16.2),
a thickness (t) of the arc profiles (16.1, 16.2), and
a stiffness of the suspension (17.1, 17.2).

8. The fuel cell stack (1) according to claim 1, wherein the first spring element and the second spring element occupy differently large surface area portions in directions perpendicular to the stacking direction.

9. The fuel cell stack according to claim 1, wherein the carrier pair of at least one of the spring elements is suspended in the stacking direction in alignment with a cavity that is formed at or in the outer covering element and can be charged with a fluid for an adjustment of a pressing force of the at least one spring element.

10. The fuel cell stack according to claim 9, wherein its own respective cavity in the outer covering element is assigned to the first spring element and the second spring element and these cavities can charged with a fluid independently of each other.

11. The fuel cell stack according to claim 1, wherein at least one of the fuel cells is segmented, that is, is divided into at least two segments.

12. The fuel cell stack according to claim 1, wherein the respective arc profile and the respective receptacle are are configured and arranged so that, in an unbraced state, the arc profile rests only with its maximum, but, in the braced state, rests flush over its curvature in the concave receptacle.

13. A method for manufacturing a fuel cell stack according to claim 1, wherein
the fuel cells as well as the inner covering element and the outer covering element are assembled,
wherein a respective arc profile of the outer covering element is arranged in a respective receptacle of the inner covering element,
and wherein the outer covering element is braced against the inner covering element and thus against the fuel cells and, in the course thereof, the spring elements are also braced.

14. A propulsion unit for an airplane or aircraft, having a fuel cell stack according to claim 1.

15. The fuel cell stack according to claim 1, wherein the fuel cell stack is configured and arranged for use in an airplane or aircraft.

16. The propulsion unit according to claim 14, wherein the propulsion unit is configured and arranged for use in an airplane or aircraft.
